(19) United States
(12) Patent Application Publication
(10) Pub. No.: US 2020/0258067 A1
(43) Pub. Date: Aug. 13, 2020

(54) SYSTEM AND METHOD FOR OPERATING AN SCO SURFACE AREA OF A RETAIL STORE

(71) Applicant: Everseen Limited, Blackpool (IE)

(72) Inventors: Alan O'Herlihy, Glenville (IE); Ovidiu Parvu, Timisoara (RO); Alexandru Arion, Timisoara (RO)

(21) Appl. No.: 16/689,356

(22) Filed: Nov. 20, 2019

Related U.S. Application Data
(60) Provisional application No. 62/803,695, filed on Feb. 11, 2019.

(51) Int. Cl. G06Q 20/20; H04N 7/18; G08B 13/196

(52) U.S. Cl. CPC G06Q 20/206; G06Q 20/208; G08B 13/19663; G08B 13/1961; H04N 7/185

(57) ABSTRACT

A system for operating a plurality of self-checkout (SCO) terminals of an SCO surface area of a retail store includes a central camera to capture an overview image of the SCO surface area, and a central control unit. The central control unit includes a memory, and a central processing unit configured to identify a non-scan event at an SCO terminal, check if the number of other already locked SCO terminals is less than a first threshold, lock the SCO terminal if the number of other locked SCO terminals is less than the first threshold, check if a number of consecutive non-scan events at the SCO terminal has reached a second threshold, if the number of other locked SCO terminals has reached the first threshold, and lock the SCO terminal, if the number of consecutive non-scan events detected at the SCO terminal has reached the second threshold.

### TECHNICAL FIELD

The present disclosure relates generally to a retail store, and more specifically to operating a self-check out (SCO) surface area of the retail store.

### BACKGROUND

Self-checkout (SCO) terminals provide a mechanism for customers to process their own purchases from a retailer. They are an alternative to the traditional cashier-staffed checkout. A typical retail store includes an SCO surface area, i.e. a region, where several SCO terminals are located. At an SCO terminal, the customer is required to scan each item with a scanner themselves, and then execute the requisite payment.

A customer may have little or no training in the operation of an SCO terminal, and may make errors when self-checking out their items. The customer may unintentionally miss some items while scanning, and may exit the store without making a requisite payment. Further, shop-lifting is a major disadvantage associated with SCO terminals. For example, a customer may not scan some items intentionally, and place the unscanned items in their shopping cart, and may exit the store without making full payment. As a result, the retail stores may incur large losses. There exists systems that detect a mismatch between the products present in a shopping basket of the user, and a scanned list of items generated by the scanner. In the event of a mismatch, such system issues an alert to the store tenders, and lock the corresponding SCO terminal, i.e. the customer cannot continue with product scanning.

However, locking of an SCO terminal leads to an increase in the overall time spent by the corresponding user therein, thereby leading to increased queues and reduced customer satisfaction in the SCO surface area. Also, in the SCO surface area, the number of store tenders is limited, which adds to the overall wait times if more SCO terminals require tender attention. In view of the above, there is required a system and method of operating the retail store, that reduces queues and increases customer satisfaction in the SCO surface area.

### SUMMARY

In an aspect of the present disclosure, there is provided a system for operating a plurality of self-checkout (SCO) terminals of an SCO surface area of a retail store. The system includes a central camera to capture an overview image of the SCO surface area, and a central control unit communicatively coupled to processor of each SCO terminal. The central control unit includes a memory to store one or more instructions, and a central processing unit communicatively coupled to the memory to execute the one or more instructions. The central processing unit is configured to identify a non-scan event at an SCO terminal, check if the number of other already locked SCO terminals is less than a first threshold, lock the SCO terminal if the number of other locked SCO terminals is less than the first threshold, if the number of other locked SCO terminals has reached the first threshold, a check is performed to determine if a number of consecutive non-scan events at the SCO terminal has reached a second threshold, and if the number of consecutive non-scan events detected at the SCO terminal has reached the second threshold, the SCO terminal is locked.

In another aspect of the present disclosure, there is provided a method for operating a plurality of self-checkout (SCO) terminals of an SCO surface area of a retail store. The method includes capturing an overview image of the SCO surface area by a central camera, identifying a non-scan event at an SCO terminal, checking if the number of other already locked SCO terminals is less than a first threshold, locking the SCO terminal if the number of other locked SCO terminals is less than the first threshold, if the number of other locked SCO terminals has reached the first threshold, checking if a number of consecutive non-scan events at the SCO terminal has reached a second threshold, and locking the SCO terminal, if the number of consecutive non-scan events detected at the SCO terminal has reached the second threshold.

In yet another aspect of the present disclosure, there is provided a computer programmable product for operating a plurality of self-checkout (SCO) terminals of an SCO surface area of a retail store, the computer programmable product comprising a set of instructions. The set of instructions when executed by a processor causes the processor to capture an overview image of the SCO surface area by a central camera, identify a non-scan event at an SCO terminal, check if the number of other already locked SCO terminals is less than a first threshold, lock the SCO terminal if the number of other locked SCO terminals is less than the first threshold, if the number of other locked SCO terminals has reached the first threshold, a check is performed to determine if a number of consecutive non-scan events at the SCO terminal has reached a second threshold, and lock the SCO terminal, if the number of consecutive non-scan events detected at the SCO terminal has reached the second threshold.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates a retail store environment, wherein various embodiments of the present invention can be practiced;

FIG. 2 illustrates a central control unit for operating an SCO surface area of a retail store, in accordance with an embodiment of the present disclosure; and

FIG. 3 is an illustration of steps of a method of operating the SCO surface area of the retail store, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

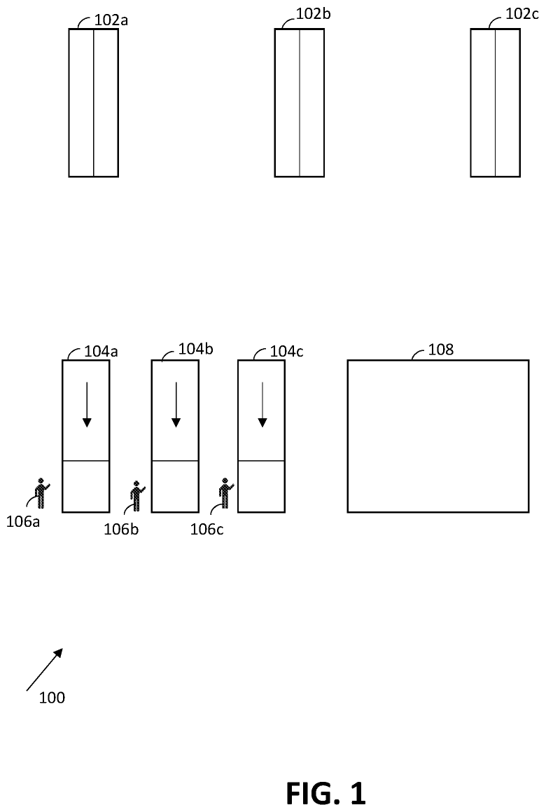

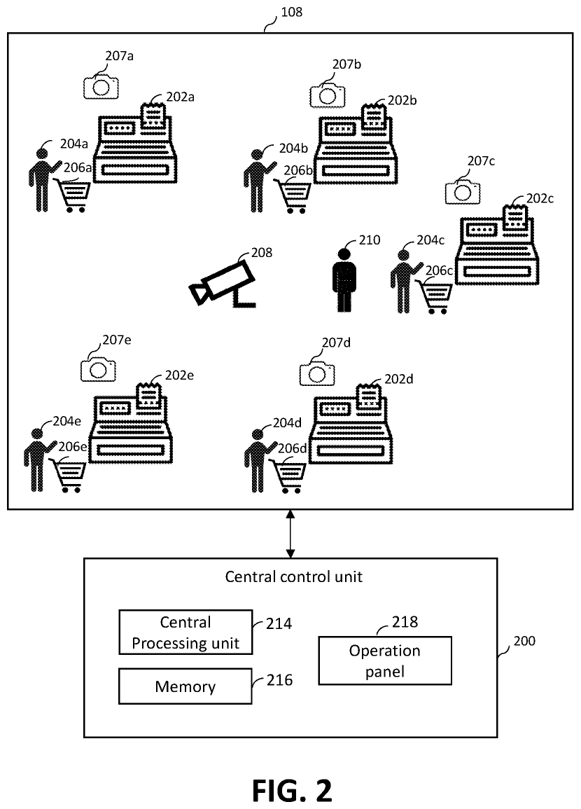

Referring to FIG. 1, there is shown a retail store environment 100, wherein various embodiments of the present disclosure can be practiced. The retail store environment 100 includes first through third shelves 102a to 102c for storing and displaying one or more items. The retail store environment 100 further includes first through third cashier terminals 104a to 104c, equipped with first through third cashiers 106a to 106c respectively to scan and bill the items present in the shopping cart of corresponding customers. The retail store environment 100 further includes a Self-Check Out (SCO) surface area 108 that includes one or more SCO terminals to enable respective customers to scan and bill the items present in their shopping cart by themselves. The SCO surface area 108 is further explained in detail with reference to FIG. 2.

FIG. 2 illustrates a central control unit 200 for operating the SCO surface area 108 of a retail store, in accordance with an embodiment of the present disclosure. The SCO surface area 108 includes first through fifth self-checkout (SCO) terminals 202a to 202e (hereinafter referred to as SCO terminals 202), corresponding first through fifth customers 204a to 204e along with their first through fifth shopping carts 206a to 206e, a central camera 208, and one or more store tender 210.

In an embodiment of the present disclosure, various components of the SCO surface area 108 may be communicatively coupled to the central control unit 200 through a communication network. The communication network may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof. In an example, the network may include a mobile communication network, for example, 2G, 3G, 4G, or 5G mobile communication network. The communication network may be coupled to one or more other networks, thereby providing coupling between a greater number of devices. Such can be the case, for example, when networks are coupled together via the Internet.

Each SCO terminal 202a to 202e is equipped with a scanner for enabling corresponding customer to scan one or more items themselves, and a user display for enabling a user to make requisite selection and payment of one or more items. In an example, the scanner may be a bar code scanner for scanning bar code of an item, for identifying the item thereof. Preferably, the scanner is a stationary wall or table-mounted scanner, designed for check-out counters of supermarkets, and other retail stores, for scanning items placed in a scanning zone. In the context of the present disclosure, the scanning zone is an area in front of the scanner where the user brings up the items for scanning for the purpose of buying of those items. Each SCO terminal 202a to 202e may include a processor (not shown) for recording scanning of one or more items, and providing instructions on corresponding user display for payment of one or more scanned items. In an embodiment of the present disclosure, the processor of each SCO terminal 202a to 202e may be communicatively coupled to the central control unit 200, for enabling the central control unit 200 to control the operations of the SCO terminals 202, and also process information captured by the central camera 208.

In an embodiment of the present disclosure, each SCO terminal 202a to 202e, is equipped with one or more overhead cameras 207a to 207e respectively to continuously capture the scanning zone of corresponding SCO terminal 202a to 202e, in order to facilitate detection of a scan irregularity due to a mismatch in the items brought up for scanning by the user, and the actual items scanned at each SCO terminal 202a to 202e. The scan irregularity occurs when an item identified for scanning during a predefined time interval is absent in a list of scanned items generated by the scanner during corresponding interval. In an example, a user may place an item in the scanning zone of the scanner, but the user may hold the item in such a way that the bar code of the item may not be visible to the bar code scanner. In such case, the user may place the item in their shopping bag after performing the scan action, but in reality, it may not be scanned by the scanner, and the user may not receive a bill for that item. In an embodiment of the present disclosure, the overhead cameras 207a to 207e may be communicatively coupled to the central control unit 200 such that the central control unit 200 is configured to control the the operations of overhead cameras 207a to 207e, and to also process information captured by the camera 208.

The central camera 208 is configured to generate an overview image of the whole SCO surface area 108. Examples of the central camera 208, include an overhead 360° camera, a 180° camera, and the like. In an embodiment of the present disclosure, the central camera 208 may be communicatively coupled to the central control unit 200, for enabling the central control unit 200 to control the the operations of central camera 208, and also process information captured by the central camera 208. The central camera 208 may facililate client experience enhancement in the SCO surface area 108, for example, a customer with children or an overflowing shopping cart may be detected by the central camera 208 at an entry point in the SCO surface area 108, and the store tender 210 may be alerted to offer support in the check-out process. If no attendant is available, support may be offered with priority when an attendant becomes available.

Although not shown, the central control unit 200 may be communicatively coupled to a computing device of the store tender 210 to issue alerts/notifications or instructions therein.

In an embodiment of the present disclosure, various components of the SCO surface area 108 may be communicatively coupled to the central control unit 200 through a communication network. The communication network may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof. In an example, the network may include a mobile communication network, for example, 2G, 3G, 4G, or 5G mobile communication network. The communication network may be coupled to one or more other networks, thereby providing coupling between a greater number of devices. Such can be the case, for example, when networks are coupled together via the Internet.

In an embodiment of the present disclosure, the central control unit 200 includes a central processing unit 214, a memory 216 and an operation panel 218. The central processing unit 214 includes a processor, computer, microcontroller, or other circuitry that controls the operations of various components such as the operation panel 218, and the memory 216. The central processing unit 214 may execute software, firmware, and/or other instructions, for example, that are stored on a volatile or non-volatile memory, such as the memory 216, or otherwise provided to the central processing unit 214. The central processing unit 214 may be connected to the operation panel 218, and the memory 216, through wired or wireless connections, such as one or more system buses, cables, or other interfaces.

The operation panel 218 may be a user interface and may take the form of a physical keypad or touchscreen. The operation panel 218 may receive inputs from one or more users relating to selected functions, preferences, and/or authentication, and may provide and/or receive inputs visually and/or audibly.

The memory 216, in addition to storing instructions and/or data for use by the central processing unit 214, may also include user information associated with one or more operators of the SCO surface area 108. For example, the user information may include authentication information (e.g. username/password pairs), user preferences, and other user-specific information. The central processing unit 214 may access this data to assist in providing control functions (e.g. transmitting and/or receiving one or more control signals) related to operation of the operation panel 218, and the memory 216.

In an embodiment of the present disclosure, the central processing unit 214 is configured to detect one or more scan irregularities based on information received from the overhead cameras 207a to 207e and the scanners of the SCO terminals 202a to 202e, and lock corresponding one or more SCO terminals 202a to 202e based on detected scan irregularities, i.e. the customer cannot continue with product scanning. Upon locking, the central processing unit 214 may issue an alert to the store tender 210 accordingly. In the context of the present disclosure, the SCO tender 210 may verify manually if the reported scan irregularities are valid.

In an embodiment of the present disclosure, the central processing unit 214 is configured to automatically lock an SCO terminal such as the first SCO terminal 202a based on a locking status of other SCO terminals. In an example, the central processing unit 214 is configured to lock the first SCO terminal 202a, when a scan irregularity is detected therein, and when the number of already locked other SCO terminals such as the second and third SCO terminals 202b and 202c is less than a first threshold. When the number of already locked other SCO terminals is greater than the first threshold, then the central processing unit 214 disables locking of the first SCO terminal 202a unless the scan irregularities detected at the first SCO terminal 202a has reached a second threshold.

In another embodiment of the present disclosure, the central processing unit 214 is configured to automatically lock an SCO terminal such as the first SCO terminal 202a based on a location of the store tender or SCO surface area supervisor 210, and their status i.e., whether he is free, or busy. The location effectively means physical location, and the physical location of the store tender and the location of the SCO terminal in question is used to determine distance between them. A smaller distance would mean shorter response time from the store tender 210. To take advantage of this, the central processing unit 214 would have the capability to lock the first SCO terminal 202a only if the store attendant in within a pre-defined distance from the SCO terminal. If the distance is greater than the pre-defined distance, then the central processing unit 214 would not lock the first SCO terminal 202a.

In yet another embodiment of the present disclosure, the central processing unit 214 is configured to automatically lock an SCO terminal such as the first SCO terminal 202a based on a length of sequence of non-scan events per SCO terminal, since last locking. It may be possible that although non-scan events occurred at the first SCO terminal 202a, the central processing unit 214 do not lock the terminal, in order to decrease customer friction. In an example, during Black Friday, the central processing unit 214 may be configured to ignore the first three non-scan events of the first SCO terminal 202a. However, if a fourth non-scan event occurs at the first SCO terminal 202a, then the first SCO terminal 202a may be locked.

In yet another embodiment of the present disclosure, the central processing unit 214 is configured to automatically lock an SCO terminal such as the first SCO terminal 202a based on a state of a corresponding cart, for example a full cart (a cart with a lot of products), a bulk loaded cart (a cart with a few items, but in large quantities), or a cart with large objects (i.e., a TV). The large objects are those objects whose size is larger than a predefined threshold size. Also, the scanning of bulk loaded cart is much faster because it involves scanning of few items, and then manually entering the number of occurrences of that item. In an example, the central processing unit 214 may be configured to lock a first SCO terminal 202a when a full cart or bulk loaded cart is detected, and a store tender is available nearby, so that the corresponding customer would receive assistance from the store tender 210. The central processing unit 214 is further configured to notify the store tender 210 for proactive assistance, when a full cart or a bulk loaded cart is being detected at the entry of the SCO surface area 108.

In yet another embodiment of the present disclosure, the central processing unit 214 is configured to automatically lock an exit gate of the SCO surface area 108, and issue a notification for the store tender 210 when a large product is being moved through the exit of SCO surface area 108, without appearing scanned in the list of scanned products. The exit gate is a gate of the retail store, through which the products may be taken out, after the self-check out process is completed.

In yet another embodiment of the present disclosure, the central processing unit 214 is configured to notify the store tender 210 to investigate when a product has changed possession from one customer to another.

In yet another embodiment of the present disclosure, the central processing unit 214 is configured to send an alert to a computing device of the store tender 210 when a size of queue at the entrance of the SCO surface area 108 is greater than a predefined third threshold, so that more potentially available attendants could be assigned to the area. The alert may be in form of an audible signal, visual display, haptic alert, instant message, etc. The entrance of the SCO surface area 108 may be an entry point from where the customers enter the SCO surface area 108 for initiating self-check out process. The central processing unit 214 may be configured to change the first and second thresholds, when the queue length at an entry in the SCO surface area 108 is above a third threshold. In the context of the present disclosure, the queue length may be automatically determined using a 360 degree camera.

In yet another embodiment of the present disclosure, the central processing unit 214 is configured to automatically lock an SCO terminal based on emergency events, for example, someone having a gun. In an embodiment of the present disclosure, the emergency situations may be detected using video cameras and the central camera 208. In an example, someone having (actually waving) a gun may be detected using the central camera 208.

In an embodiment of the present disclosure, the above-mentioned parameters may be pre-configured by a store manager of corresponding retail store, or someone who manages the whole security system. Based on the pre-configured parameters, real-time information captured by the central camera 208 and overhead cameras 207a to 207e, state of SCO terminals 202, state of SCO attendants 210, the central processing unit 214 automatically controls the locking of the SCO terminals 202, and send messages to the store tender 210, and the store manager. In an embodiment of the present disclosure, the central processing unit 214 is configured to dynamically create and adapt store-customer interactions of each SCO terminal 202a to 202e of the SCO surface area 108, and optimizes customer flow at the SCO terminals 202. The SCO terminal may be unlocked upon intervention of the store tender/attendant/SCO surface area supervisor 210.

In various embodiments of the present disclosure, the central processing unit 214 is configured to reduce overall waiting queues and increase customer satisfaction in the SCO surface area 108, by weighing the cost of tender intervention at SCOs 202a to 202e with the cost of potential product leakage (products which may leave the store without being billed). In an embodiment of the present disclosure, the central processing unit 214 may be configured to calculate a cost value for every minute of customer wait time and for every leaked product. This cost may be weighted against the cost of another leaked product. The central processing unit 214 may be further configured to predict aggregated wait times by taking into account the number of locked terminals, the number of store attendance in the area, and the queue length at entry in the SCO area, and build a model indicating how many more minutes of wait time may be added if a new alert is triggered.

FIG. 2 is merely an example. One of ordinary skill in the art would recognize many variations, alternatives, and modifications of embodiments herein.

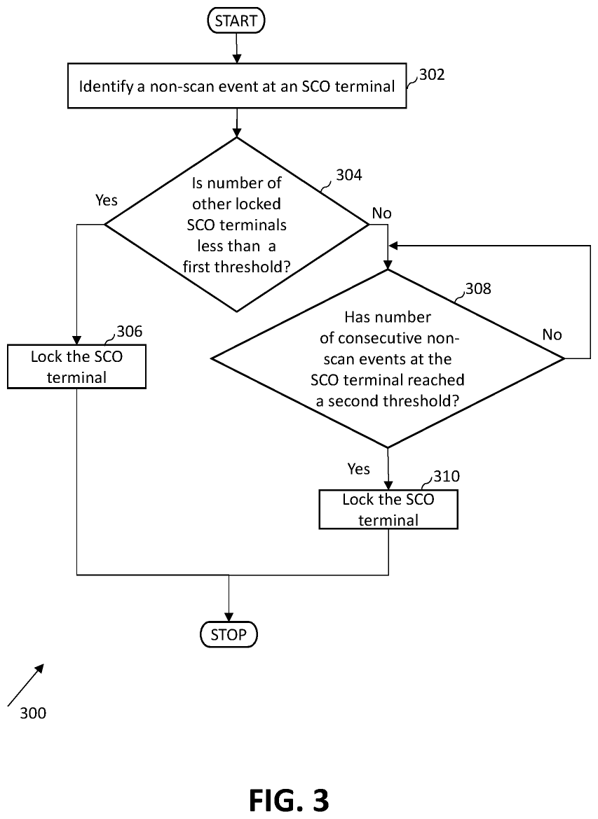

FIG. 3 is an illustration of steps of a method 300 of operating an SCO surface area 108 by a central processing unit 214 the central control unit 200, in accordance with the present disclosure. The method is depicted as a collection of steps in a logical flow diagram, which represents a sequence of steps that can be implemented in hardware, software, or a combination thereof.

At a step 302, a non-scan event is identified at an SCO terminal of an SCO surface area. The non-scan event is referred to as an event when the user brings up an item for scanning in the scanning zone of corresponding scanner, but it may or may not be successfully scanned by the scanner. In an example, a user may place an item in the scanning zone of the scanner, but the user may hold the item in such a way that the bar code of the item may not be visible to the bar code scanner. The action corresponding to non-scan event may not be captured by the scanner, but it may be captured by the overhead camera disposed therein.

At a step 304, a check is performed to determine if the number of other locked SCO terminals is less than a first threshold, and at step 306, the SCO terminal is automatically locked, if the number is less than the first threshold. The value of the first threshold may be set based on the number of SCO terminals and store tenders in corresponding SCO surface area.

If the number of other locked SCO terminals has reached than the first threshold, at step 308, a check is performed to determine if a number of consecutive non-scan events at the SCO terminal has reached a second threshold.

At step 310, the SCO terminal is automatically locked, if the number of consecutive non-scan events detected has reached the second threshold. In an example, the value of the first threshold may be 2, and the value of the second threshold may be 3. Thus, when, there are already at least two terminals that are locked, then a third terminal would be locked only if the current non-scan event is a third non-scan event in the current transaction.

FIG. 3 is merely an example. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for operating a plurality of self-checkout (SCO) terminals of an SCO surface area of a retail store, the system comprising:
a central camera to capture an overview image of the SCO surface area; and
a central control unit communicatively coupled to a processor of each SCO terminal and to the central camera, wherein the central control unit comprises:
a memory to store one or more instructions; and
a central processing unit communicatively coupled to the memory to execute the one or more instructions, wherein the central processing unit is configured to:
identify a non-scan event at an SCO terminal;
check if the number of other already locked SCO terminals is less than a first threshold;
lock the SCO terminal if the number of other locked SCO terminals is less than the first threshold;
if the number of other locked SCO terminals has reached the first threshold, perform a check to determine whether a number of consecutive non-scan events at the SCO terminal has reached a second threshold; and
if the number of consecutive non-scan events detected at the SCO terminal has reached the second threshold, lock the SCO terminal.

2. The system of claim 1, wherein the central camera is selected from a group consisting of: a 360° camera, and a 180° camera.

3. The system of claim 1, wherein the central control unit is communicatively coupled to a computing device of a store tender of the SCO surface area for issuing alerts, notifications and instructions thereto.

4. The system of claim 1, wherein the central processing unit is configured to automatically lock a SCO terminal if a non-scan event is detected at the SCO terminal, and a distance between the SCO terminal and a store tender is less than a predetermined distance.

5. The system of 1, wherein the central processing unit is configured to automatically lock a SCO terminal if a number of non-scan events occurred at the SCO terminal has reached a third threshold.

6. The system of claim 1, wherein the central processing unit is configured to automatically lock a SCO terminal based on a state of shopping cart of corresponding customer.

7. The system of claim 1, wherein the central processing unit is configured to automatically lock an exit gate of the SCO surface area, and issue a notification to a store tender when a large product is being moved through the exit gate, without appearing in corresponding list of scanned products.

8. The system of claim 1, wherein the central processing unit is configured to issue a notification to a store tender, when a size of queue at an entrance of the SCO surface area is greater than a fourth threshold.

9. A method for operating a plurality of self-checkout (SCO) terminals of an SCO surface area of a retail store, the method comprising:
capturing an overview image of the SCO surface area by a central camera;
identifying a non-scan event at an SCO terminal;
checking if the number of other already locked SCO terminals is less than a first threshold;
locking the SCO terminal if the number of other locked SCO terminals is less than the first threshold;
if the number of other locked SCO terminals has reached the first threshold, checking if a number of consecutive non-scan events at the SCO terminal has reached a second threshold; and
if the number of consecutive non-scan events detected at the SCO terminal has reached the second threshold, locking the SCO terminal.

10. The method of claim 9, wherein the central camera is selected from a group consisting of: a 360° camera, and a 180° camera.

11. The method of claim 9 further comprising automatically locking a SCO terminal if a non-scan event is detected at the SCO terminal, and a distance between the SCO terminal and a store tender is less than a predetermined distance.

12. The method of claim 9 further comprising automatically locking a SCO terminal if a number of non-scan events occurred at the SCO terminal has reached a third threshold.

13. The method of claim 9 further comprising automatically locking a SCO terminal based on a state of shopping cart of corresponding customer.

14. The method of claim 9 further comprising automatically locking an exit gate of the SCO surface area, and issuing a notification to a store tender when a large product is being moved through the exit gate, without appearing in corresponding list of scanned products.

15. The method of claim 9 further comprising issuing a notification to a store tender, when a size of queue at an entrance of the SCO surface area is greater than a fourth threshold.

16. A computer programmable product for operating a plurality of self-checkout (SCO) terminals of an SCO surface area of a retail store, the computer programmable product comprising a set of instructions, the set of instructions when executed by a processor that causes the processor to:
capture an overview image of the SCO surface area by a central camera;
identify a non-scan event at an SCO terminal;
check if the number of other already locked SCO terminals is less than a first threshold;
lock the SCO terminal if the number of other locked SCO terminals is less than the first threshold;
if the number of other locked SCO terminals has reached the first threshold, perform a check to determine if a number of consecutive non-scan events at the SCO terminal has reached a second threshold; and
if the number of consecutive non-scan events detected at the SCO terminal has reached the second threshold, lock the SCO terminal.

17. The computer programmable product of claim 16, wherein an SCO terminal is automatically locked if a non-scan event is detected at the SCO terminal, and a distance between the SCO terminal and a store tender is less than a predetermined distance.

18. The computer programmable product of claim 16, wherein an SCO terminal is automatically locked if a number of non-scan events occurred at the SCO terminal has reached a third threshold.

19. The computer programmable product of claim 16, wherein an exit gate of the SCO surface area is automatically locked, and a notification is issued to a store tender when a large product is being moved through the exit gate, without appearing in corresponding list of scanned products.

20. The computer programmable product of claim 16, wherein a notification is issued to a store tender, when a size of queue at an entrance of the SCO surface area is greater than a fourth threshold.
